(19) United States
(12) Patent Application Publication
(10) Pub. No.: US 2013/0152870 A1
(43) Pub. Date: Jun. 20, 2013

(54) DOG MOBILITY DEVICE

(71) Applicant: Alycia Lamb, Seattle, WA (US)

(72) Inventor: Alycia Lamb, Seattle, WA (US)

(21) Appl. No.: 13/328,683

(22) Filed: Dec. 16, 2011

(51) Int. Cl. A01K 15/02

(52) U.S. Cl. 119/702

(57) ABSTRACT

An innovative dog mobility device is disclosed herein an comprises an elastic cord detachably connectable to a dog harness at one end, and to paw loop at the other. The paw loop is configured to engage one of the dog's paws and is defined by a material strip looped into a figure eight configuration. The material strip figure eight configuration further defines an metatarsal strap section and a toe strap section, wherein the metatarsal strap section is configured to receive and fit about the dog's metatarsus, and wherein the toe strap section is configured to receive and fit about the dog's inner toes.

### TECHNICAL FIELD

The present invention relates generally to dog therapy and/or dog training devices and, more specifically, to a mobility device for dogs having a hind limb weakness caused by, for example, canine degenerative myelopathy.

### BACKGROUND OF THE INVENTION

Canine degenerative myelopathy (also known as chronic degenerative radiculomyelopathy) is a progressive disease of the spinal cord that afflicts some older dogs. The disease has an insidious onset that typically occurs between 7 and 14 years of age. It begins with a loss of coordination (ataxia) in the hind limbs. The disease is chronic and progressive, and generally results in paralysis.

Degenerative myelopathy initially affects the back legs and causes muscle loss and weakness, as well as lack of coordination. These generally have a staggering affect on the animal and may appear to be arthritis. The dog may drag one or both rear paws when it walks. This dragging or knuckling can cause the nails of one foot to be worn down. The condition may lead to extensive paralysis of the back legs. As the disease progresses, the animal may display symptoms such as incontinence, and may lead to considerable difficulties with both balance and walking If allowed to progress, the animal will generally show front limb involvement and extensive muscle atrophy. Eventually cranial nerve or respiratory muscle involvement may necessitate euthanasia.

Progression of the disease is generally slow but highly variable. The animal may be crippled within a few months, or may survive up to three years or more. Degenerative myelopathy is a non-reversible, progressive disease with no known cure. Moreover, there are no treatments that have been clearly shown to stop or slow progression of degenerative myelopathy. Exercise, however, has been recommended to maintain the dog's ability to walk. Physiotherapy, for example, may prolong the length of time that the dog remains mobile and increase survival time. Canine hydrotherapy (swimming) may be more useful than walking Use of a belly sling/leash allows the dog handler the ability to support the dog's hind legs while exercising or going up and down stairs. A cart 2 may enable the dog to remain active and maintain its quality of life once weakness or paralysis of the hind legs sets in.

Although various dog therapy and training devices are known in the art, they all have various shortcomings (especially in terms of preventing or minimizing the dragging or knuckling of a dog's paw). Exemplary devices known in the art for assisting dog mobility include:

U.S. Pat. No. 2,534,727 to Moyle discloses a complicated dog training harness that consists of non-stretchable belts and straps configured to restrain or retard certain movements of the dog.

U.S. Pat. No. 3,215,117 to Short discloses a small cart for dogs afflicted with posterior paralysis or other related affiliation of the hind limbs. The innovative cart allows an otherwise lame dog to become ambulatory and self-propelling.

U.S. Pat. No. 4,528,544 to Reed et al. discloses a dog exercising harness that consists of a chest harness connected to a central pulley and an elastic cord. The elastic cord, in turn, is attached the rear legs of the dog. The length and tension of the cord are selected to cause added resistance to movement of the dog's hind legs. The dog training device to Reed et al. is for strength and conditioning of an otherwise healthy dog.

U.S. Pat. No. 7,150,248 to Hödl discloses a dog therapy device that consists of a chest harness connected to an elastic chord that, in turn, is connected to an metarsal cuff. The metatarsal cuff is positioned just beneath the dog'metatarsus joint and above the dog's paw. The dog therapy device to Hödl, however, does not prevent dragging or knuckling of the dog's paws/toes because it only applies forward tension to the dog's hind leg, and not any upward tension to the dog's paw.

Because each of these known devices has one or more shortcomings (especially in terms of preventing knuckling and/or dragging of a dog's toes), there is still a need in the art for new and improved dog therapy and/or dog training devices. The present invention fulfills this need and provides for further related advantages.

### SUMMARY OF THE INVENTION

In brief, the present invention in an embodiment is directed to a dog mobility device for assisting the forward movement of a hind leg of a dog and with the upward movement of the dog's toes. The innovative dog mobility device comprises an elastic 3 cord detachably connectable as well as the upward movement of the paw/toes of the dog to a dog harness at one end, and to a paw loop at the other. The paw loop is configured to engage one of the dog's paws, and is defined by a material strip looped into a figure eight configuration. The material strip figure eight configuration further defines an metatarsal strap section and a toe strap section, wherein the metatarsal strap section is configured to receive and fit about the dog's metatarsus, and wherein the toe strap section is configured to receive and fit about the dog's two inner toes. In this configuration, the inventive dog mobility device is able to assist with the forward movement of the dog's hind leg (as well as with the upward movement of the dog's paw/toes), while at the same time preventing dragging and/or knuckling of the dog's paw.

These and other aspects of the present invention will become more readily apparent to those possessing ordinary skill in the art when reference is made to the following detailed description in conjunction with the accompanying drawings.

### BRIEF DESCRIPTION OF THE DRAWINGS

The drawings are intended to be illustrative of certain preferred embodiments of the present invention. Like reference numerals have been used to designate like features throughout the several views of the drawings.

FIG. 1 is a pictorial representation of a dog (named Reilly) fitted with a chest harness that is connected to a dog mobility device in accordance with an embodiment of the present invention.

FIG. 2 is a pictorial view of a dog mobility device (shown apart from a dog) in accordance with an embodiment of the present invention.

FIG. 3 is a pictorial view of the paw loop portion of the dog mobility device shown in FIG. 2.

FIG. 4 is a bottom view of a paw loop engaged (fitted) about the metatarsal and two innermost toes of a dog in accordance with an embodiment of the invention.

FIG. 5 is a side view of the paw loop shown in FIG. 4 (and shown connected to a lower rearward end portion of an elastic cord of the inventive dog mobility device).

### DETAILED DESCRIPTION OF THE INVENTION

In the following detailed description, reference is made to the accompanying drawings, which form a part hereof. In the drawings, similar symbols or markings typically identify like or corresponding elements, unless context dictates otherwise. The illustrative embodiments described in the detailed description, drawings, and claims are not meant to be limiting. Other embodiments may be utilized, and other changes may be made, without departing from the spirit or scope of the subject matter presented herein.

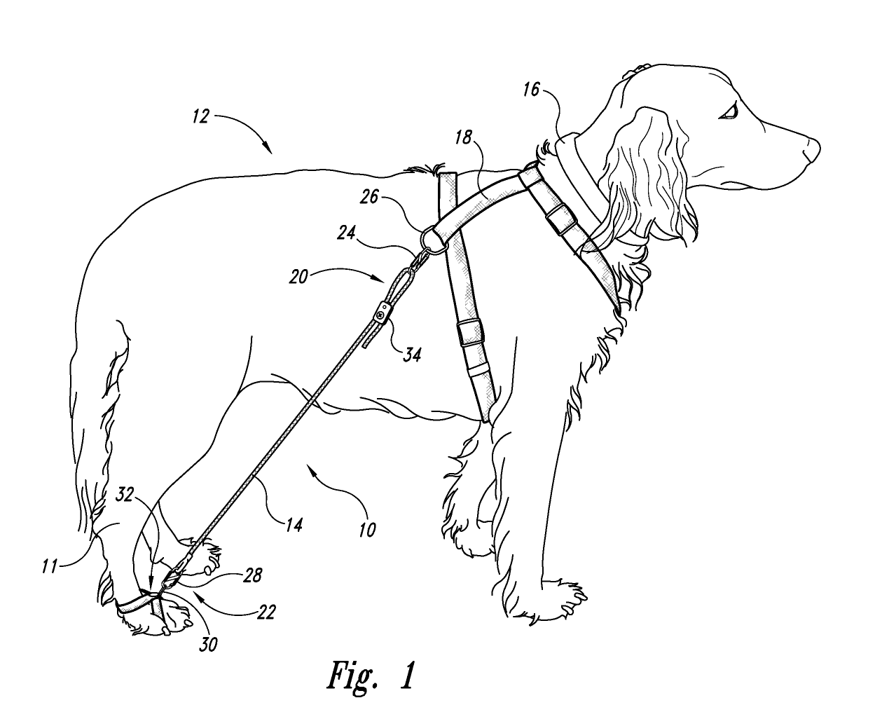

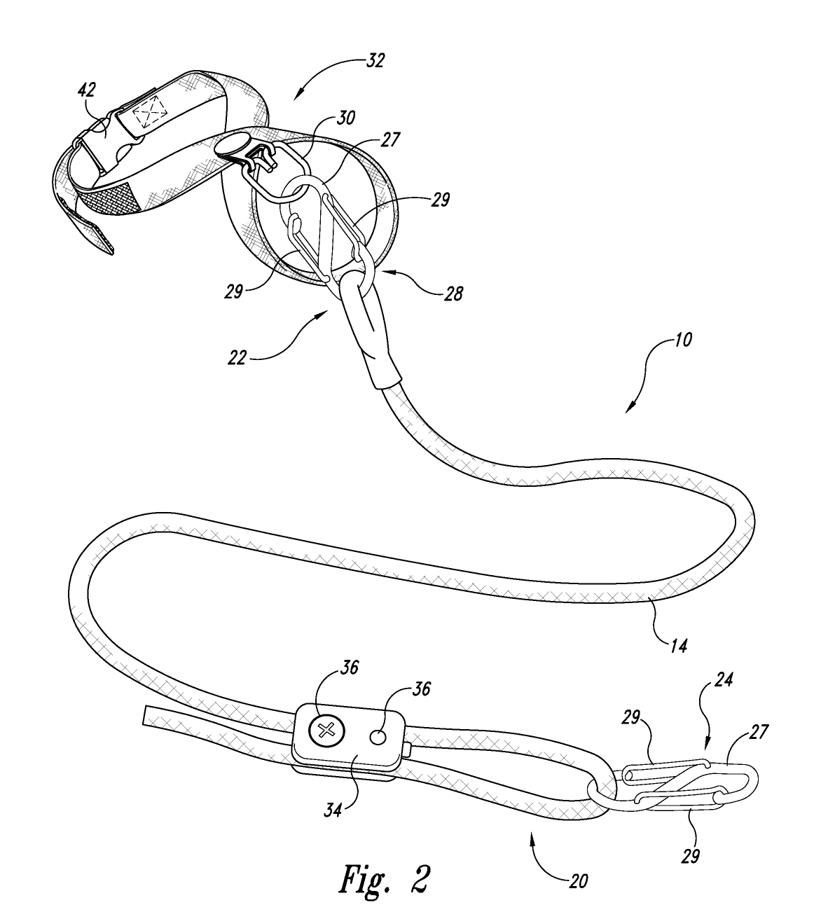

Thus, and in view of the foregoing and referring now to the drawings, and more particularly to FIGS. 1 and 2, the present invention is directed to a dog mobility device 10 configured to assist with the forward movement of a hind leg 11 of a dog 12. The dog mobility device 10 comprises at least one elastic cord 14 that is detachably connectable to a dog harness 18. The dog mobility device is shown in FIG. 1 as being connected to a top section of dog harness 18; however, it is expressly understood that the dog mobility device 10 may be connected at other locations. The elastic (stretchable) cord 14 includes an upper forward end portion 20 and a lower rearward end portion 22.

As shown in FIGS. 1 and 2, the upper forward end portion 20 of the elastic cord 14 is detachably connectable to an upper connection clip 24, which, in turn, is detachably connectable to a rearwardly extending ring member 26 of the dog harness 18. Similarly, the lower rearward end portion 22 of the elastic cord 14 is detachably connectable to a lower connection clip 28, which, in turn, is detachably connectable to a forwardly extending ring member 30 of a paw loop 32. The upper and lower connection clips 24, 26 may each be in the form of an S-shaped hook 27 having opposing latches 29 (for opening and closing of the hook 27). The upper forward end portion 20 of the elastic cord 14 preferably also includes a cord length adjusting clamp 34 for adjusting the overall length of the elastic cord 14. As shown, the upper forward end portion 20 of the elastic cord 14 loops through the upper connection clip 24 and back through the cord length adjusting clamp 34. The cord length adjusting clamp 34 (having a small section of the elastic cord 14 running through it in a side-by-side fashion) may be tightened or loosened by way of one or more oppositely positioned threaded screws 36.

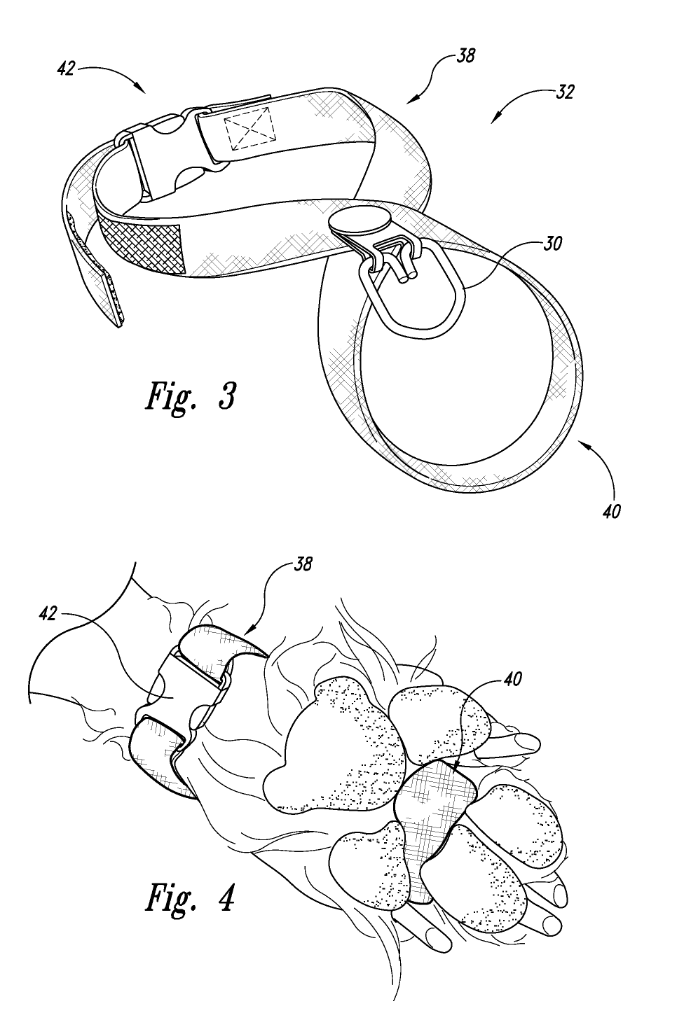

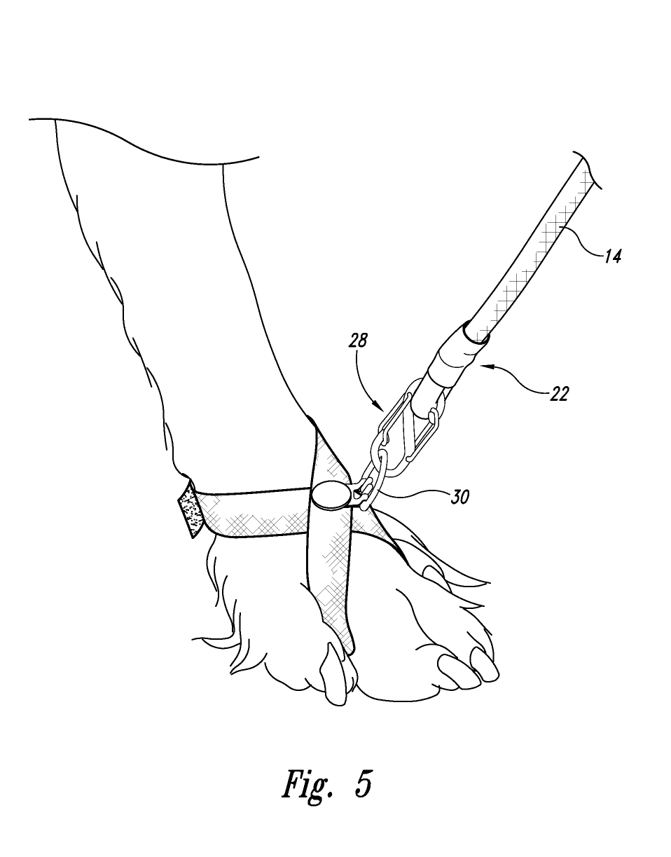

The dog mobility device 10 of the present invention also comprises a paw loop 32 detachably connectable to the elastic cord 14 by way of the forwardly extending ring member 30 (that is centrally connected to the paw loop 32). As shown best shown in FIGS. 2, 3, and 5, the forwardly extending ring member 30 may be both swivelable and rotatable. As best shown in FIGS. 3 and 5, the paw loop 32 is configured to engage (fit about) one of the dog's paws and is defined by a material strip looped into a figure eight configuration. The material strip figure eight configuration further defines an metatarsal strap section 38 and a toe strap section 40 (with the forwardly extending ring member 30 being positioned at the intersection of the metatarsal strap section 38 and the toe strap section 40). The metatarsal strap section 38 is configured to receive and fit about the dog's metatarsal, whereas the toe strap section 40 is configured to receive and fit about the dog's two inner toes. The metatarsal strap section 38 also includes a rearwardly facing snap connector 42 and is adjustable about the dog's metatarsus by way of confronting pieces of VELCRO adhered to an end portion of the material strip. In this configuration, the dog mobility device 10 is better able to assist with the forward movement of the dog's hind leg 11 because it pulls (applies tension to) the dog's paw in an upward and forward direction, as opposed to just pulling the dog's hind leg forward (which may nevertheless result in knuckling or dragging of the dog's toes).

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing descriptions, and all changes that come within the meaning and range of equivalency of the claims are to be embraced within their scope.

What is claimed is:

1. A dog mobility device for assisting with the forward movement of a hind leg of a dog and with the upward movement of the dog's toes, the dog mobility device comprising:
at least one elastic cord connectable to a dog harness, wherein the at least one elastic cord includes an upper forward end portion and a lower rearward end portion; and
a paw loop connectable to the lower rearward end portion of the elastic cord, wherein the paw loop is configured to engage one of the dog's paws, and wherein the paw loop is defined by a material strip looped into a figure eight configuration, and wherein the material strip figure eight configuration further defines an metatarsal strap section and a toe strap section, and wherein the metatarsal strap section is configured to receive and fit about the dog's metatarsus, and wherein the toe strap section is configured to receive and fit about the dog's two innermost toes.

2. The dog mobility device of claim 1 further comprising, an upper connection clip connected to the upper forward end portion of the at least one elastic cord, and a lower connection clip connected to the lower rearward end portion of the elastic cord.

3. The dog mobility device of claim 2 further comprising, a cord adjusting clamp positioned on the at least one elastic cord for adjusting the length of the at least one elastic cord.

4. The dog mobility device of claim 3 further comprising, a forward extending ring member positioned on the paw loop at the intersection of the metatarsal strap section and the toe strap section.

5. The dog mobility device of claim 4 wherein the forward extending ring member is rotatable and swivelable.
